(19) United States
(12) Patent Application Publication
(10) Pub. No.: US 2002/0001721 A1
(43) Pub. Date: Jan. 3, 2002

(54) Structure comprising a fluoro primer and electrode based on this structure

(75) Inventors: Benoit Barriere, Barc (FR); Michael Burchill, Langhorne, PA (US); Yoshiyuki Miyaki, Shiga (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 09/822,825

(22) Filed: Apr. 2, 2001

(30) Foreign Application Priority Data
Mar. 31, 2000 (FR) 0004201

(51) Int. Cl. B32B 15/08

(52) U.S. Cl. 428/421; 428/422; 428/463; 428/408

(57) ABSTRACT

Especially for electrodes, there is provided a structure successively comprising a layer of a metal L1, a fluoro primer L2 and a layer of a fluoro polymer L3 in which the flouro primer L2 is derived from a fluoro polymer chemically modified by a partial dehydrofluorination with a base followed by an oxidation step, especially with H₂O₂. According to one specific form, the structure is an electrode of a lithium-ion battery in which the metal L1 is the collector and the fluoro polymer L3, which has a high content of carbon and/or oxides, is the electroactive layer thereof.

The present invention relates to a structure comprising a fluoro primer and to an electrode based on this structure. More specifically, the structure successively comprises a layer of a metal, a fluoro primer and a layer of a fluoro polymer. The layer of fluoro polymer can be replaced with a fluoro polymer which has a high content of carbon and/or oxides, and as such it is an electroactive layer. The fluoro polymer is classed in this case as a binder; it gives cohesion to this electroactive layer. This structure successively comprising a layer of a metal, the fluoro primer and this electroactive layer constitutes an electrode of a lithium-ion battery.

In the preparation of lithium-ion batteries, the electroactive layer containing either mixed oxide fillers or carbon and/or graphite fillers, with other ingredients to adjust the electrical performance, is generally prepared by dispersing the fillers in a solvent in the presence of a fluoro polymeric binder. The dispersion thus obtained is deposited on a metal collector by means of a “casting” method, and the solvent is then evaporated off to give a negative or positive electrode depending on the fillers used.

The metal collectors used are generally copper foils or grilles in the case of the negative electrode and aluminium foils or grilles in the case of the positive electrode. The polymeric binder gives cohesion to the electroactive layer and ensures adhesion to the metal collector. This cohesion and this adhesion are required for the satisfactory production of the batteries.

Poor cohesion of the layer does not make it possible, for example, to roll up or stack the electrodes within the multilayer structure of the battery without any harmful crumbling of the electroactive material taking place. This major drawback is also produced when the adhesion to the collector is insufficient.

The performance levels of the battery depend closely on the characteristics of the binder. A good binder makes it possible to prepare layers with a sufficient content of electroactive ingredients relative to the amount of binder required, and thus makes it possible to have a high specific capacity. The binder should also be stable with respect to redox reactions during the charging and discharging cycles, and should also be insensitive to the electrolyte present in the battery. This electrolyte typically contains solvents of carbonate type such as propylene carbonate, ethylene carbonate or dimethylethyl carbonate and a lithium salt such as LiPF₆ or LiBF₄. PVDF or VF₂ copolymers are materials which have the characteristics for their use as lithium battery binders.

Prior art WO 97/27260 describes a structure successively comprising (i) a fluoro polymer, (ii) an adhesive consisting of a mixture of two polymers chosen from PVDF homopolymer, an acrylic polymer and a copolymer based on VF₂ (vinylidene fluoride) and (iii) a metallic layer. It also describes lithium-ion battery electrodes consisting of an electroactive layer whose binder is of composition (ii) deposited on a copper or aluminium foil.

Prior art WO 97/32347 describes lithium-ion battery electrodes consisting of an electroactive layer whose binder is a fluoro polymer grafted with an acrylic polymer, the said electroactive layer being deposited on a copper or aluminium foil.

Whether it is a matter of the adhesion of fluoro polymers to metals or the adhesion of the electroactive layers based on fluoro polymers in lithium-ion batteries, effort is constantly being made to improve the adhesion. It has now been found that a fluoro polymer chemically modified by a partial dehydrofluorination followed by an oxidation can constitute a primer for reinforcing the adhesion:

in a structure successively comprising a layer of a metal, a fluoro primer and a layer of a fluoro polymer, or

in a lithium-ion battery electrode successively comprising a layer of a metal (the collector), the fluoro primer and the electroactive layer.

The advantage of the invention is that it is no longer necessary, in order to manufacture the electroactive layer, to use grafted fluoro polymers or mixtures of fluoro polymers that are complicated to produce. It suffices to use ordinary fluoro polymers or copolymers.

The present invention relates to a structure successively comprising a layer of a metal L1, a fluoro primer L2 and a layer of a fluoro polymer L3 in which the fluoro primer L2 originates from a fluoro polymer chemically modified by a partial dehydrofluorination followed by an oxidation.

According to one specific form, the structure of the invention is an electrode of a lithium-ion battery in which the metal L1 is the collector and the fluoro polymer L3, which has a high content of carbon and/or oxides, is the electroactive layer thereof.

As regards the metal, mention may be made, for example, of steel, stainless steel, aluminium, copper, nickel, titanium, lead, silver, chromium and the various alloys thereof.

As regards the fluoro primer L2, it originates from a fluoro polymer chemically modified by a partial dehydrofluorination followed by an oxidation. The fluoro polymer which is modified can be a fluoro plastic or a fluoro elastomer, provided that they contain units of general formula (I):

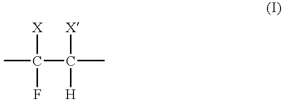

in which X and X′ can be, independently of each other, a hydrogen atom, a halogen, in particular fluorine or chlorine, or a perhalo alkyl, in particular perfluoro alkyl, in order to make the polymer thus chemically modified more adhesive to metal substrates, in particular those made of copper or aluminium.

The fluoro polymers which can be used can be prepared by polymerization or copolymerization of unsaturated olefinic monomers. To obtain a fluoro polymer having the unit of formula (I), the monomer and/or the comonomers should comprise both fluorine atoms linked to carbon atoms and hydrogen atoms linked to carbon atoms. For example, the fluoro polymers which can be used can be homopolymers prepared from hydrofluorocarbon-based monomers, or can be copolymers derived from unsaturated perfluoro mononers copolymerized with one or more unsaturated monomers containing hydrogen —H, i.e. a hydrofluorocarbon-based monomer and/or a non-fluoro monomer.

As examples of unsaturated olefinic monomers which can be used, mention may be made of hexafluoropropylene (HFP), tetrafluoroethylene (TFE), vinylidene fluoride (VF₂), chlorotrifluoroethylene (CTFE), 2-chloropentafluoropropene, perfluoroaklyl vinyl ethers such as CF₃—O—CF═CF₂ or CF₃—CF₂—O—CF═CF₂, 1-hydropentafluoropropene, 2-hydro-pentafluoropropene, dichlorodifluoroethylene, trifluoroethylene, 1, 1-dichlorofluoroethylene, and perfluoro-1,3-dioxols such as those described in U.S. Pat. No. 4,558,142, and unsaturated olefinic monomers containing no fluorine, such as ethylene, propylene, butylene and higher homologues.

Diolefins containing fluorine can be used, for example diolefins such as perfluorodiallyl ether and perfluoro-1,3-butadiene.

The unsaturated olefinic monomers or comonomers can be polymerized to obtain a fluoro polymer by the processes known in the prior art for fluoro polymers.

In particular, as regards the processes for synthesizing poly(vinylidene fluoride) (PVDF), U.S. Pat. No. 3,553,185 and EP 0 120 524 describe processes for synthesizing PVDF by placing vinylidene fluoride (VF₂) in aqueous suspension and polymerizing it. U.S. Pat. No. 4,025,709, U.S. 4,569,978, U.S. 4,360,652, U.S. 626,396 and EP 0 655 468 describe processes for synthesizing PVDF by placing VF₂ in aqueous emulsion and polymerizing it.

In general, the unsaturated olefinic fluoro monomers can be polymerized and optionally copolymerized with non-fluoro olefinic monomers in aqueous emulsions. The emulsions contain, for example, a water-soluble initiator such as an ammonium or alkalki metal persulphate or alternatively an alkali metal permanganate, which produce free radicals, and also contain one or more emulsifiers such as ammonium or alkali metal salts of a perfluorooctanoic acid.

Other processes in aqueous colloidal suspension use initiators that are essentially soluble in the organic phase, such as dialkyl peroxides, alkyl hydroperoxides, dialkyl peroxydicarbonates or azoperoxides, the initiator being combined with colloids such as methylcelluloses, methylhydroxypropylcelluloses, methylpropylcelluloses and methylhydroxyethylcelluloses.

Many fluoro polymers and copolymers are commercially available, in particular those from the company Elf Atochem S.A. under the brand name Kynar®.

Preferably, the fluoro polymer which is modified to convert it into L2 is in the form of an aqueous dispersion, such as an emulsion or a suspension. This dispersion can be the product resulting from one of the synthetic methods recalled above.

Preferably, the polymer which is modified to convert it into L2 is PVDF homopolymer or a VF₂/HFP copolymer.

This fluoro polymer is subjected to a partial dehydrofluorination with a base and the fluoro polymer thus partially dehydrofluorinated is then reacted with an oxidizing agent to give a novel fluoro polymer L2.

This dehydrofluorination of the fluoro polymer is obtained by means of a base in aqueous medium or in an organic solvent. Bases which can be used are mentioned in WO 98/08880. They may be, for example, a hydroxide such as potassium hydroxide (KOH), ammonium hydroxide (NH₄OH), sodium hydroxide (NaOH), lithium hydroxide (LiOH), a carbonate such as potassium carbonate (K₂CO₃) or sodium carbonate (Na₂CO₃), a tertiary amine, a tetraalkylammonium hydroxide or a metal alkoxide. A process of dehydrofluorination in aqueous medium of a fluoro polymer emulsion is also described in patent application WO 98/08879. The base can be used with or without catalyst. The base can also be an amine derivative of hydrocarbon-based structure which is soluble or partially soluble in water or organic solvents, in particular 1,8-diazabicyclo[5.4.0]undec-7-ene (DBU) or 1,4-diazabicyclo[2.2.2]octane (DABCO).

The catalyst can be, for example, tetrabutylammonium bromide (TBAB) or tetraalkylphosphonium, alkylarylphosphonium, alkylammonium and alkylphosphonium halides. The basic compound and the optional catalyst can be dissolved or diluted in a solvent such as naphthalene, tetrahydrofuran (THF) and water.

Preferably, the oxidation is obtained by means of hydrogen peroxide (H₂O ₂) in heterogeneous aqueous medium. Specifically, hydrogen peroxide in aqueous phase affords an advantageous process by minimizing the refuse compared with a process using an organic solvent. Hydrogen peroxide in aqueous phase also allows a simplified treatment of the effluents compared with other oxidizing agents. However, other oxidizing agents, which are active in aqueous medium, can be used, for example palladium halides or chromium halides, in particular PdCl₂ and CrCl₂, alkali metal permanganates, for example KMnO₄, peracids, alkyl peroxides or persulphates, optionally combined with H₂O₂.

Advantageously, the reaction or the contact with aqueous H₂O₂ is carried out at a pH ranging from 6.5 to 8 and preferably from 6.7 to 7.6. The reason for this is that for a pH below 6.5, the reaction is very slow, and for a pH above 8, there is a risk of the H₂O₂ decomposition reaction becoming uncontrolled.

Advantageously, the reaction or the contact with H₂O₂ is carried out at a temperature ranging from 20° C. to 100° C. and better still from 500° C. to 900°C.

Advantageously, the total amount of H₂O₂ added, calculated on the basis of the pure peroxide, is from 1 to 50% by weight relative to the total weight of the reaction medium. Preferably, this amount ranges from 2 to 12%.

The modified polymers L2 according to the process of the present invention have adhesion and cohesion properties that are highly increased compared with fluoro polymers that are not chemically modified. These improved properties solve the problem of adhesion on the collectors of the electroactive layers of fluoro polymer L3 containing oxides or carbon.

The MFI (Melt Flow Index) of L2 is advantageously between 0.2 and 5 g/10 min (at 230° C. under a 10 kg load) for L2 derived from the PVDF homopolymer, and between 2 and 10 g/10 min (at 230° C. under a 5 kg load) for L2 derived from the copolymer of VF₂ and HFP.

The thickness of the layer of primer on the metal L1 can be between 1 and 10 μm and preferably 1 and 2 μm for the electrodes of lithium-ion batteries.

As regards the fluoro polymer L3, it can be chosen from polymers or copolymers containing units of general formula (I) mentioned above for the polymers which are treated to produce L2.

By way of example of fluoro polymers L3, mention will be made most particularly of

PVDF, vinylidene fluoride (VF₂) homopolymers and vinylidene fluoride (VF₂) copolymers preferably containing at least 50% by weight of VF₂ and at least one other fluoro monomer such as chlorotrifluoroethylene (CTFE), hexafluoropropylene (HFP), trifluoroethylene (VF₃) or tetrafluoroethylene (TFE),

trifluoroethylene (VF₃) homopolymers and copolymers,

copolymers, and in particular terpolymers, combining the residues of chlorotrifluoroethylene (CTFE), tetrafluoroethylene (TFE), hexafluoropropylene (HFP) and/or ethylene units and optionally VF₂ and/or VF₃ units.

Among these fluoro polymers L3, PVDF is advantageously used.

The MVI (MFI by volume) of L3 is advantageously between 0.5 and 25 cm³/10 min (at 230° C. under a 5 kg load).

According to one specific form of the invention, the layer of fluoro polymer L3 can have a high content of carbon and/or oxides and as such is an electroactive layer. The fluoro polymer is classed in this case as a binder, and gives cohesion to this electroactive layer. The layers containing mixed oxides of lithium of the type LiMₓO_{y} (in which M is a transition metal such as Mn, Ni or Co) or containing carbons of various types (graphites or specific carbons used as compounds for intercalating the lithium ions) are used to prepare, respectively, the positive electrodes (for the mixed oxide fillers) and negative electrodes (for the carbon fillers) in lithium-ion batteries.

Thus, the present invention also relates to:

a positive electrode for a lithium-ion battery according to the above structure, in which the metal L1 is preferably aluminium, the fluoro primer L2 is derived from a fluoro polymer chemically modified by a partial dehydrofluorination followed by an oxidation, and the layer of fluoro polymer L3 comprising mixed oxide particles is the electroactive layer;

a negative electrode for a lithium-ion battery according to the above structure, in which the metal L1 is preferably copper, the fluoro primer L2 is derived from a fluoro polymer chemically modified by a partial dehydrofluorination followed by an oxidation, and the layer of fluoro polymer L3 comprising carbon particles is the electroactive layer.

### EXAMPLE 1

### Preparation of a Chemically Modified Polyvinylidene Fluoride

In this example, the fluoro polymer used as starting material is a polyvinylidene fluoride (PVDF) latex prepared according to the emulsion process as described in U.S. Pat. No. 4,025,709. After drying at 105° C. for 24 hours, this latex gives a dry powder. This powder, when melted, has a flow index of 0.6 to 1 g/10 min at 230° C. under 10 kg. This latex, referred to as Latex 1 hereinbelow, contains 40% by weight of PVDF. The process according to the present invention can, however, be applied in particular to any PVDF latex or VF₂ copolymer obtained by an emulsion process or to any suspension of PVDF or VF₂ copolymer obtained by a suspension process.

Dehydrofluorination Step

To begin with, 7.2 kg of an aqueous sodium hydroxide solution containing 15% by weight of NaOH in water is prepared in a stirred 20 liter reactor. This solution is brought to 70° C. and 7.2 kg of Latex 1, optionally diluted in deionized water so as to have a given solids content, are then added thereto at a rate of 0.72 kg/min with stirring at 180 rpm. A brown-coloured coagulated emulsion is thus obtained, which turns even darker the further the degradation proceeds. Depending on the duration of the dehydrofluorination reaction, a fine black powder is obtained which gradually becomes insoluble in the usual organic solvents, in particular dimethylformamide (DMF) or N-methylpyrrolidone (NMP).

Step of Reacting With an Oxidizing Agent

The reaction medium, still stirred and maintained at a temperature of 70° C., is acidified to pH=5 by adding about 2.5 kg of hydrochloric acid at a concentration of 36% by weight. 1.68 kg of hydrogen peroxide at a concentration of 35% by weight are then added at a rate of 0.4 kg/min, and the pH is then increased to a value of between 6.6 and 7.6 by adding a sodium hydroxide solution containing 15% by weight of NaOH. The mixture is left to react while maintaining the pH between 6.6 and 7.6 by addition of the same sodium hydroxide solution. A gradual decolorization of the coagulated emulsion is observed, which turns pale yellow to ochre.

Finishing

The solid coagulate in suspension is filtered off to give a pale yellow powder which is washed with three dispersions in 20 liters of water with stirring and successive filtrations. A powder is thus obtained which is dried in an oven at 105° C. to constant weight.

Characterization

The characterization of the product of this powder is carried out by measuring the absorbance at 300 mm which is obtained by analysis with a Perkin-Elmer LC-75 spectrophotometer using a concentration of 0.1% by weight of product in NMP. The dissolution time before carrying out the measurements is 24 hours.

### EXAMPLE 2

### Preparation of a Polyvinylidene Fluoride Homopolymer and of Two Copolymers of Polyvinylidene Fluoride and of Hexafluoropropene (HFP) that are Chemically Modified

These tests are carried out in a similar manner to that of Example 1 under the following experimental conditions and with the following analytical results:

| | | | | | | | Absorbence |
|---|---|---|---|---|---|---|---|
| | | | | Solids | | Oxidation | at 300 nm in |
| | | % by mass | | content of | Degradation | treatment | solution in |
| Sample | Starting latex | of HFP | Melt index | the latex | time (min) | time (mm) | NMP |
| A | Kynar ® 50 | 0 | 0.6-1(¹) | 42% | 30 | 150 | 0.19 |
| B | Kynar ® 50 | 0 | 0.6-1(¹) | 42% | 60 | 150 | 0.206 |
| C | Kynar ® 50 | 0 | 0.6-1(¹) | 42% | 90 | 200 | 0.262 |
| D | Kynarflex ® 2800 | 11 | 0.8-1(²) | 11% | 230 | 75 | 0.154 |
| E | Kynarflex ® 2750 | 15 | 3-4(²) | 20% | 250 | 75 | 0.174 |

(¹)at 230° C. under 10 Kg
(²)at 230° C. under 5 Kg

### EXAMPLE 3

### Preparation of a PVDF Coating 1 to 2 μm Thick on a Metal Foil

3 g of polyvinylidene fluoride are dissolved in 97 g of N-methyl-2-pyrrolidone (abbreviated to NMP hereinbelow, from Merck, purity>99%) with magnetic stirring at 55° C. for at least 30 minutes (up to 4 h for grades which are difficult to dissolve). Once cooled, this solution is applied with a brush or a cloth to the metal foil (copper for the negative electrode or aluminium for the positive electrode) and the solvent is then evaporated off at 120° C. for 10 minutes. The thickness of the layer of PVDF thus formed on the metal ranges between 1 and 2 μm.

### EXAMPLE 4

### Preparation of a PVDF Coating on an Aluminium Foil Coated or not Coated With a Primer

10 g of polyvinylidene fluoride are dissolved in 90 g of NMP with magnetic stirring at 55° C. for at least 30 minutes (up to 4 h for grades which are difficult to dissolve). Once cooled, this solution is spread onto an aluminium foil 20 μm thick, coated or not coated with a primer, and a film is then formed by means of a manual Doctor Blade scraper. The film is dried at 120° C. in a ventilated oven for 30 minutes. The layer of PVDF thus formed on the metal is about 40 μm thick.

### EXAMPLE 5

### Preparation of a Solution for Forming a Negative Electrode for an Li-ion Battery

5 g of polyvinylidene fluoride are dissolved in 85 g of NMP with magnetic stirring at 55° C. for at least 30 minutes (up to 4 h for grades which are difficult to dissolve). 45 g MCMB 6-28 graphite powder with an average particle size of 6 μm obtained from Osaka Gaz, are added to this solution. These powders are dispersed in the solution by magnetic stirring at room temperature for 30 minutes, and then for 3 minutes in a Dispermat brand multi-paddle turbomixer at high stirring speed (2000 rpm).

### EXAMPLE 6

### Preparation of a Negative Electrode for an Li-ion Battery

The solution of Example 5 is spread on a copper foil 20 μm thick and a film is then formed by means of a manual Doctor Blade scraper set at 400 μm. The film is dried at 90° C. in a ventilated oven for 15 minutes, and then at 140° C. under vacuum overnight. The conductive layer thus formed on the copper foil is thus composed of 10% by weight of polyvinylidene fluoride and 90% of graphite. Its density, or “weight per unit area”, is about 12 g/cm² and its average thickness is 120 μm.

### Example 7

### Preparation of a Solution to Form a Positive Electrode for an Li-ion Battery

3 g of polyvinylidene fluoride are dissolved in 62 g of NMP with magnetic stirring at 55° C. for at least 30 minutes (up to 4 h for grades which are difficult to dissolve). 1.5 g of conductive carbon black powder of acetylene type (Denka Black) and 45.5 g of LiCoO₂ powder with an average particle size of 5 μm, obtained from Union Minière, are added to this solution. These powders are dispersed in the solution by magnetic stirring at room temperature for 30 minutes, and then for 3 minutes in a Dispermat brand multi-paddle turbomixer at high stirring speed (2000 rpm).

### Example 8

### Preparation of a Positive Electrode for an Li-ion Battery

The solution of Example 7 is spread on an aluminium foil 20 μm thick and a film is then formed by means of a manual Doctor Blade scraper set at 350 μm. The film is dried at 90° C. in a ventilated oven for 15 minutes, and then at 140° C. under vacuum overnight. The conductive layer thus formed on the aluminium foil is thus composed of 6% by weight of polyvinylidene fluoride, 3% of conductive carbon black and 91% of LiCoO₂. Its density, or “weight per unit area”, is about 1.9 g/cm² and its average thickness is 120 μm.

### EXAMPLE 9

### Determination of the Adhesion Properties Between the Conductive Layer and the Metal Foil

Strips 25 mm wide and at least 10 cm long are cut out in the assembly described in Example 4, Example 6 or Example 8 and then attached to a rigid metal support by means of a double-sided adhesive tape (of brand TESA, reference #4970) of the same width onto the conductive layer side. The assembly is pressed against the support by simply pressing by hand. The rigid metal support+double-sided adhesive tape+conductive layer+metal foil is referred to as the “peeling test piece”.

The peeling test pieces are then installed on a DY30 dynamometer distributed by Adamel Lhomargy. The metal support is kept fixed. Rupture between the conductive layer and the aluminium foil is initiated either by hand or using a razor blade. The free part of the aluminium foil is fixed to a mobile jaw and is then pulled at 180° at a pulling speed of 100 mm/min. The instantaneous tensile force is determined by means of a force cell used of 10 N. The average value of this force during the peeling between the metal foil and the conductive layer is referred to as the “peeling force”.

### EXAMPLE 10

### Comparison of a PVDF Coating With or Without Primer

Kynar® 761 sold by Elf Atochem is used to form a coating according to Example 4 on an aluminium foil, which is uncoated or coated with a primer of the chemically modified PVDF homopolymer “A” of Example 2 according to Example 4. If the aluminium foil is not coated with a primer, the Kynar® 761 does not adhere to the aluminium. If the aluminium foil is coated with a primer of the chemically modified PVDF homopolymer “A” of Example 2, the Kynar® 761 adheres to the aluminium, and using the process described in Example 9, the peeling force between the Kynar® 761 coating and the aluminium foil can be measured as 0.22 N/25 mm with a standard deviation of 0.06 N/25 mm.

### Example 11

### Comparison of a Negative Electrode With or Without Primer

Kynar®761 sold by Elf Atochem is used to form a negative electrode according to Example 5 and Example 6, which is uncoated or coated with a primer of chemically modified PVDF homopolymers “A”, “B” and “C” of Example 2 according to Example 4, or with a primer of the chemically modified PVDF/HPF copolymers “D” and “E” of Example 2 according to Example 4. The chemically modified PVDF homopolymer “A” of Example 2 or the PVDF homopolymer KF-1300 from Kureha (market “standard”) is also used to form a negative electrode according to Example 5 and Example 6 and to compare them with the previous ones. Using the process described in Example 9, the peeling force between the conductive layer and the aluminium foil can be measured, and the results are collated in the table below:

| | | Peeling force |
|---|---|---|
| Binder used | Primer | (g/25 mm) |
| Kynar ® 761 | no | 55 |
| Kynar ® 761 | A | 110 |
| Kynar ® 761 | B | 200 |
| Kynar ® 761 | C | 200 |
| Kynar ® 761 | D | 170 |
| Kynar ® 761 | E | 200 |
| A | no | 220 |
| KF-1300 | no | 140 |

Thus, a PVDF homopolymer which is a binder of medium quality, such as Kynar® 761, can be used in the manufacture of a negative electrode together with a primer for a chemically modified PVDF homopolymer or for a chemically modified PVDF/HFP copolymer to form an electrode of good quality, as is evidenced by the comparison with the electrodes manufactured with KF-1300 or the chemically modified PVDF homopolymer “A”.

### EXAMPLE 12

### Comparison of a Positive Electrode With or Without Primer

Kynar® 761 sold by Elf Atochem is used to form a positive electrode according to Example 7 and Example 8, which is uncoated or coated with a primer for the chemically modified PVDF homopolymers “A”, “B” and “C” of Example 2 according to Example 4. The chemically modified PVDF homopolymer “A” of Example 2 or the PVDF homopolymer KF-1300 from Kureha (market “standard”) is also used to form a negative electrode according to Example 7 and Example 8 and to compare them with the previous ones. Using the process described in Example 9, the peeling force between the conductive layer and the aluminium foil can be measured, and the results are collated in the table below:

| | | Peeling force |
|---|---|---|
| Binder used | Primer | (g/25 mm) |
| Kynar ® 761 | no | 25 |
| Kynar ® 761 | A | 430 |
| Kynar ® 761 | B | 450 |
| Kynar ® 761 | C | 400 |
| A | no | 340 |
| KF-1300 | no | 60 |

Thus, a PVDF homopolymer which is a binder of medium quality, such as Kynar® 761, can be used in the manufacture of a positive electrode together with a primer for a chemically modified PVDF homopolymer to form an electrode of good quality, as is evidenced by the comparison with the electrodes manufactured with KF-1300 or the chemically modified PVDF homopolymer “A”.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 00/04.201, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. A structure comprising successively a layer of a metal L1, a fluoro primer L2 and a layer of a fluoro polymer L3 in which the fluoro primer L2 is derived from a fluoro polymer chemically modified by a partial dehydrofluorination followed by an oxidation step sufficient to increase adhesion of L3 to L1.

2. A structure according to claim 1, in which the polymer to be chemically modified contains repeating units of formula (I): 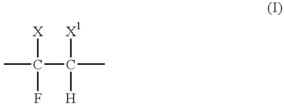
in which X and X¹ can be, independently of each other, a hydrogen atom or a halogen.

3. A structure according to claim 2, wherein at least one of X and X¹ is fluorine, chlorine or perfluoroalkyl.

4. A structure according to claim 2, wherein at least one of X and X¹ is perfluoroalkyl.

5. A structure according to claim 2, in which the polymer to be chemically modified is PVDF homopolymer or a VF₂/HFP copolymer.

6. An electrode comprising the structure according to claim 1, in which the metal L1 is the collector and the fluoro polymer L3, comprises a high content of at least one electroactive component selected from the group consisting of carbon and an oxide.

7. An electrode according to claim 6, in which the layer of fluoro polymer L3 comprises mixed oxide particles.

8. An electrode according to claim 6, wherein the metal L1 is aluminum.

9. An electrode for a lithium-ion battery according to claim 4, in which the layer of fluoro polymer L3 comprises carbon particles.

10. An electrode according to claim 9, wherein the metal is copper.

11. A lithium-ion battery comprising an electrode according to claim 7, as a positive electrode.

12. A lithium-ion battery comprising an electrode according to claim 9, as a negative electrode.

13. A structure comprising a layer of a metal L1 and a layer of a fluoro primer L2 derived from a fluoro polymer chemically modified by partial dehydrofluorination followed by an oxidation step sufficient to increase adhesion.

14. A fluoro polymer containing repeating units of formula (I): 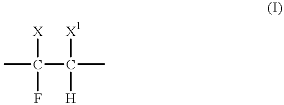
in which X and X¹ can be, independently of each other, a hydrogen atom or a halogen, said fluoro polymer having been chemically modified by a partial dehydrofluorination followed by an oxidation step.

15. A process for producing the fluoro polymer of claim 14, comprising providing said fluoropolymer of formula (I), subjecting said fluoro polymer to partial dehydrofluorination in a basic medium, and subjecting the resultant partially dehydrogenated fluoro polymer to oxidation with hydrogen peroxide.
